(19) United States
(12) Patent Application Publication
(10) Pub. No.: US 2015/0349307 A1
(43) Pub. Date: Dec. 3, 2015

(54) METHOD FOR PREPARING A COATED LITHIUM BATTERY COMPONENT

(71) Applicant: GM GLOBAL TECHNOLOGY OPERATIONS LLC, Detroit, MI (US)

(72) Inventors: Gayatri Vyas Dadheech, Bloomfield Hills, MI (US); Mei Cai, Bloomfield Hills, MI (US); Li Yang, Troy, MI (US)

(21) Appl. No.: 14/721,683

(22) Filed: May 26, 2015

Related U.S. Application Data
(60) Provisional application No. 62/003,373, filed on May 27, 2014.

(51) Int. Cl. H01M 2/14; H01M 10/052; H01M 10/0525; H01M 4/04; H01M 4/139

(52) U.S. Cl. CPC H01M 2/145; H01M 4/0402; H01M 4/0409; H01M 4/0419; H01M 4/139; H01M 10/0525; H01M 10/052

(57) ABSTRACT

In an example of a method for preparing a coated lithium battery component, the lithium battery component is selected from the group consisting of a porous membrane, a positive electrode, and a negative electrode. The lithium battery component is coated with a precursor. The precursor includes a mixture of an electrolyte solvent, a lithium compound, and a monomer. Coating the lithium battery component forms a precursor coating on the lithium battery component. The precursor coating on the lithium battery component is exposed to a plasma jet, which causes the polymerization of the precursor to form a polymer coating on the lithium battery component.

### CROSS-REFERENCE TO RELATED APPLICATIONS

This application claims the benefit of U.S. Provisional Patent Application Ser. No. 62/003,373, filed May 27, 2014, which is incorporated by reference herein in its entirety.

### BACKGROUND

Secondary, or rechargeable, lithium-sulfur batteries or lithium ion batteries are often used in many stationary and portable devices, such as those encountered in the consumer electronic, automobile, and aerospace industries. The lithium class of batteries has gained popularity for various reasons including a relatively high energy density, a general nonappearance of any memory effect when compared to other kinds of rechargeable batteries, a relatively low internal resistance, and a low self-discharge rate when not in use. The ability of lithium batteries to undergo repeated power cycling over their useful lifetimes makes them an attractive and dependable power source.

### SUMMARY

In an example of a method for preparing a coated lithium battery component, the lithium battery component is selected from the group consisting of a porous membrane, a positive electrode, and a negative electrode. The lithium battery component is coated with a precursor, which includes a mixture of an electrolyte solvent, a lithium compound, and a monomer. Once the lithium battery component is coated with the precursor, a precursor coating is formed on the lithium battery component. The precursor coating is exposed to a plasma jet, which causes polymerization of the precursor to form a polymer coating on the lithium battery component.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIGS. 1A and 1B are semi-schematic, perspective views which together depict an example of the method for preparing the coated lithium battery component, where FIG. 1A illustrates an example of applying a precursor to the lithium battery component to form a precursor coating, and FIG. 1B illustrates an example of exposing the precursor coating to a plasma jet to polymerize the precursor coating and form a polymer coating on the lithium battery component;

FIG. 2 is a semi-schematic, perspective view of an example of a plasma spray system for applying the precursor coating and polymerizing the precursor coating on a lithium battery component to form the polymer coating;

FIGS. 3A through 3C are cross-sectional views of various examples of the coated lithium battery component;

FIG. 4 is a schematic, perspective view of an example of a lithium-sulfur battery, where the polymer coating has been applied to at least one of the lithium battery components; and

FIG. 5 is a schematic, perspective view of an example of a lithium ion battery, where the polymer coating has been applied to at least one of the lithium battery components.

### DETAILED DESCRIPTION

Lithium-sulfur batteries and lithium ion batteries generally operate by reversibly passing lithium ions between a negative electrode (sometimes called an anode) and a positive electrode (sometimes called a cathode). The negative and positive electrodes are situated on opposite sides of a porous membrane (sometimes called a separator) soaked with an electrolyte solution that is suitable for conducting the lithium ions. Each of the electrodes is also associated with respective current collectors, which are connected by an interruptible external circuit that allows an electric current to pass between the negative and positive electrodes.

It has been found that the lithium-sulfur battery life cycle may be limited by the migration, diffusion, or shuttling of lithium-polysulfide intermediates (LiSₓ, where x is 2<x<8) from the sulfur positive electrode during the battery discharge process, through the separator, to the negative electrode. The lithium-polysulfide intermediates generated at the sulfur-based positive electrode are soluble in the electrolyte, and can migrate to the negative electrode (e.g., a silicon electrode) where they react with the negative electrode in a parasitic fashion to generate lower-order lithium-polysulfide intermediates. These lower-order lithium-polysulfide intermediates diffuse back to the positive electrode and regenerate the higher forms of lithium-polysulfide intermediates. As a result, a shuttle effect takes place. This effect leads to decreased sulfur utilization, self-discharge, poor cycleability, and reduced Coulombic efficiency of the battery. It is believed that even a small amount of lithium-polysulfide intermediates forms an insoluble final product, such as dilithium sulfide (Li₂S), which can permanently bond to the negative electrode. This may lead to parasitic loss of active lithium at the negative electrode, which prevents reversible electrode operation and reduces the useful life of the lithium-sulfur battery.

As noted above, the shuttle effect leads to decreased sulfur utilization. This is due to the fact that when the lithium-polysulfide intermediates are formed, the sulfur in the cathode is depleted. A reduced amount of sulfur in the positive electrode means that there is less sulfur available for use. The depletion of sulfur also contributes to the limited life cycle of sulfur-based batteries. It is to be understood that the lithium-polysulfide intermediates are referred to herein as polysulfides.

Similarly, it has been found that the lithium ion battery containing a lithium transition metal oxide-based positive electrode may be deleteriously affected by the dissolution of transition metal cations from the positive electrode, which results in accelerated capacity fading. The transition metal cations migrate from the positive electrode to the negative electrode of the battery, leading to its “poisoning.” In an example, a graphite negative electrode may be poisoned by Mn⁺² or Mn⁻³, Mn⁺⁴ cations that dissolve from spinel LiₓMn₂O₄ of the positive electrode. For instance, the Mn⁺² cations may migrate through the battery electrolyte and porous membrane separator, and deposit onto the graphite electrode. When deposited onto the graphite, the Mn^{|2} cations become Mn metal. It has been shown that a relatively small amount (e.g., 90 ppm) of Mn metal can poison the graphite electrode and prevent reversible electrode operation, thereby reducing the useful life of the battery. The deleterious effect of the Mn deposited at the negative electrode is significantly enhanced during battery exposure to above-ambient temperatures (>40° C.), irrespective of whether the exposure occurs through mere storage (i.e., simple stand at open circuit voltage in some state of charge) or during battery operation (i.e., during charge, during discharge, or during charge—discharge cycling).

The diffusion of polysulfide in the lithium-sulfur battery or the transition metal cations in the lithium ion battery may be reduced or prevented by incorporating an example of the coated lithium battery component disclosed herein. The coating on the coated lithium battery component is a polymer coating that incorporates a lithium compound and an electrolyte solvent therein. The incorporation of the lithium compound and the electrolyte solvent contributes, at least in part, to the polymer coating being lithium conducting. In some instances, for example, when the lithium battery component is a negative electrode, the polymer coating and negative electrode may also be pre-lithiated. The coating may be a single layer, a bilayer, or a multi-layered structure with three or more layers. The coating also includes pores sized to block/trap polysulfide ions or transition metal cations from passing through. As such, the polymer coating included on the lithium battery component(s) disclosed herein act as a barrier that may improve the capacity and useful life of the battery.

Furthermore, examples of the method for applying the polymer coating to the lithium battery component provide an efficient and economical process. The method allows for relatively fast production of the coated battery component due, in part, to coating and polymerization occurring in one or two steps.

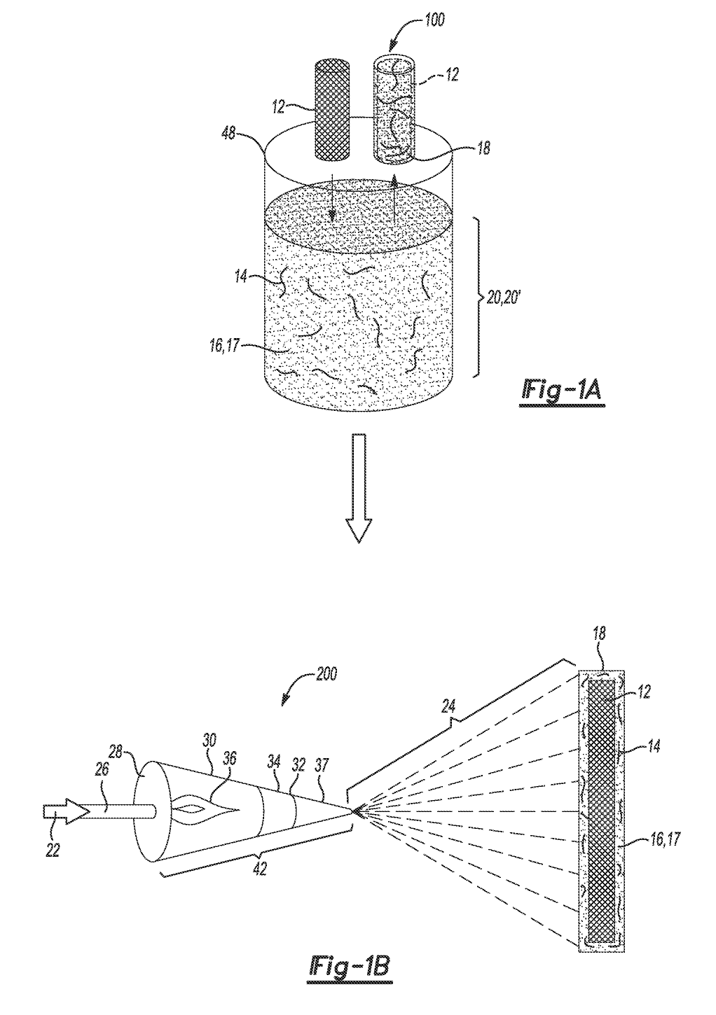

FIGS. 1A and 1B together illustrate systems 100 and 200 for performing steps of one example of the method for preparing the coated lithium battery component. These systems 100 and 200 are used in a two-step process.

Referring now to FIG. 1A, the system 100 for applying a precursor 20 to a lithium battery component 12 to form a precursor coating 18 thereon is shown. The system 100 generally includes a container 48 of the precursor 20 and the lithium battery component 12.

In an example of the method for applying or coating the precursor 20 using the system 100, a mixture 20′ is prepared. The mixture 20′ includes a monomer 14, an electrolyte solvent 16, and the lithium compound 17. Examples of the monomer 14, the electrolyte solvent 16, and the lithium compound 17 of the mixture 20′ will now be discussed.

It is to be understood that any of the monomers 14 disclosed herein may be used in either the lithium-sulfur battery or the lithium ion battery, and thus may not be selected based on the type of lithium battery in which the resulting coated lithium battery component will be used. Some of the monomers 14 that may be used will form a polymer coating that is lithium conducting, and some other of the monomers 14 that may be used may need to be exposed to additional processing steps in order to render them lithium conducting.

Some examples of the monomers 14 that form a lithium conducting polymer coating include methyl methacrylate, acrylonitrile, vinyl chloride, and ethylene glycol diacrylate (a diester formed by condensation of two equivalents of methacrylic acid and one equivalent of ethylene glycol). Methyl methacrylate and/or acrylonitrile may be also used with SiO₂ nanoparticles or Al₂O₃ nanoparticles. In another example, vinylidene fluoride and hexafluoropropylene monomers may be used to form poly(vinylidene fluoride-co-hexafluoropropene) (PVDF-HFP), which is lithium conducting. In yet another example, ethylene oxide monomers may be used to form polyethylene oxide (PEO), which is lithium conducting.

As mentioned above, monomers 14 that form a non-lithium conducting polymer coating may also be used. For example, Nafion, which is a non-lithium conducting polymer, may be formed from a tetrafluoroethylene monomer (TFE) and sulfonic acid (—SO₃⁻H^{|}) containing-perfluorinated vinyl ether. Another example of a non-lithium conducting polymer is polysulfone, which is formed from diphenol and bis(4-chlorophenyl)sulfone monomers. Diphenol may be formed from monomers of bisphenol-A or 1,4-dihydroxybenzene.

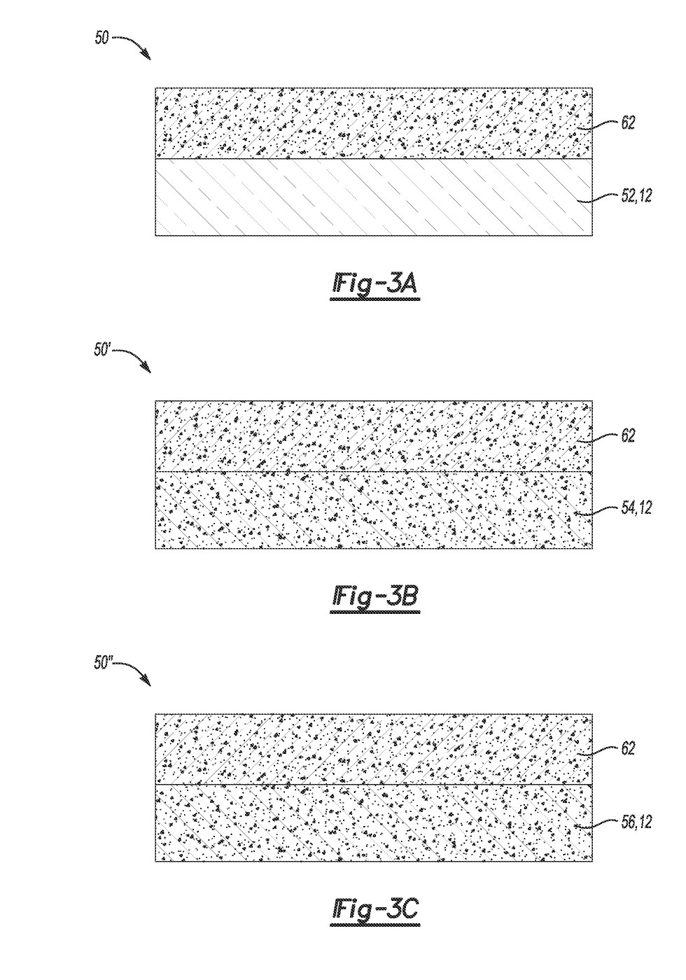

When monomers 14 are used that form non-lithium conducting polymer coatings on the lithium battery component 12, the entire coated component (shown as 50, 50′, 50″ in FIGS. 3A through 3C) may be exposed to an ion exchange process. For example, hydrogen cations (H⁺) of the Nafion-electrolyte polymer coating or the polysulfone-electrolyte polymer coating may be exchanged for Li⁺ cations. In an example, ion exchange is accomplished by soaking or immersing the Nafion-electrolyte polymer coating or the polysulfone-electrolyte polymer coating in a lithium salt solution, for example, a solution of lithium carbonate. The H⁺ cations of the coating exchange with the Li⁺ cations in the solution.

In other examples, precursors to silicon may be used as the monomer 14. Silicon or SiOₓ may be a desirable polymer coating material when the lithium battery component 12 is a negative electrode. Generally, when a precursor to silicon is selected as the monomer 14, the negative electrode lithium battery component may be porous carbon. In an example, the silicon precursor is present in the mixture 20′ in an amount ranging from about 40 wt % to about 50 wt %. Examples of silicon precursors include H₄SiO₄ (silicic acid) or H₂SiF₆ (hexafluorosilicic acid). When the silicon precursor is polymerized, it can readily form polymeric silicon or polymeric silicon oxide SiOₓ species.

The selection of a suitable electrolyte solvent 16 for the mixture 20′ and precursor 20 will depend, at least in part, on the type of battery in which the resulting coated lithium battery component will be used. For either battery, the lithium compound 17 may be any lithium salt that dissolves in the selected electrolyte solvent 16.

When the coating to be formed from the precursor 20 will be used in a lithium-sulfur battery, the electrolyte solvent 16 may include an ether based solvent, and the lithium compound 17 may be a lithium salt that dissolves in the electrolyte solvent 16. Examples of the ether based solvent include cyclic ethers, such as 1,3-dioxolane, tetrahydrofuran, 2-methyltetrahydrofuran, and chain structure ethers, such as 1,2-dimethoxyethane, 1-2-diethoxyethane, ethoxymethoxyethane, tetraethylene glycol dimethyl ether (TEGDME), polyethylene glycol dimethyl ether (PEGDME), and mixtures thereof. Examples of the lithium salt include LiClO₄, LiAlCl₄, LiI, LiBr, LiSCN, LiBF₄, LiB(C₆H₅)₄, LiAsF₆, LiCF₃SO₃, LiN(FSO₂)₂ (LIFSI), LiN(CF₃SO₂)₂ (LITFSI or Lithium Bis(Trifluoromethanesulfonyl)Imide), LiPF₆, LiB(C₂O₄)₂ (LiBOB), LiBF₂(C₂O₄) (LiODFB), LiPF₄(C₂O₄) (LiFOP), LiNO₃, and mixtures thereof.

When the coating to be formed from the precursor 20 will be used in a lithium ion battery, the electrolyte solvent 16 may include an organic solvent, and the lithium compound 17 may be a lithium salt that dissolves in the electrolyte solvent 16. Examples of the organic solvent include cyclic carbonates (ethylene carbonate, propylene carbonate, butylene carbonate, fluoroethylene carbonate), linear carbonates (dimethyl carbonate, diethyl carbonate, ethylmethyl carbonate), aliphatic carboxylic esters (methyl formate, methyl acetate, methyl propionate), γ-lactones (γ-butyrolactone, γ-valerolactone), chain structure ethers (1,2-dimethoxyethane, 1-2-diethoxyethane, ethoxymethoxyethane, tetraglyme), cyclic ethers (tetrahydrofuran, 2-methyltetrahydrofuran, 1,3-dioxolane), and mixtures thereof. Any of the previously listed examples of the lithium salts may also be dissolved in the organic solvent.

The mixture 20′ and precursor 20 may further include additional components such as a polymerization initiator and/or a polar aprotic solvent. Some examples of polymerization initiators include organic peroxides and azo-based compounds.

The polar aprotic solvent may be added to the mixture 20′ to aid in making the mixture 20′ homogenous. It is to be understood that the polar aprotic solvent is evaporated when the precursor 20 is polymerized. Examples of suitable polar aprotic solvents include acetone, dimethylacetamide (DMAc), N-methyl-2-pyrrolidone (NMP), dimethylformamide (DMF), dimethylsulfoxide (DMSO), tetrahydrofuran (THF), acetonitrile, or another Lewis base, or combinations thereof. In an example, acetone may be added to a mixture 20′ including vinylidene fluoride and hexafluoropropylene monomers. Similarly, acetonitrile may be added to a mixture 20′ including ethylene oxide monomers.

In an example, the precursor 20/mixture 20′ contains the monomer 14 and the electrolyte solvent 16 having the lithium compound 17 dissolved therein. The monomer 14 may be present in an amount ranging from about 10 wt % to about 90 wt % of the total wt % of the precursor 20/mixture 20′, and the electrolyte solvent 16 having the lithium compound 17 dissolved therein may be present in an amount ranging from about 10 wt % to about 90 wt % of the total wt % of the precursor 20/mixture 20′. To form the precursor 20, the lithium compound 17 may be dissolved in the electrolyte solvent 16, the monomer 14 may be added thereto, and the components may be stirred to form the mixture 20′. The various mixture components may also be added to another solvent (as mentioned above). In an example, the mixture 20′ may be a homogenous mixture (as observed by the human eye). A homogeneous mixture 20′ may be used to ensure that the monomer 14, electrolyte solvent 16, and the lithium compound 17 are evenly coated throughout the precursor coating 18. It is believed this contributes to the lithium battery functioning more efficiently (e.g., with a high ionic conductivity).

As shown on the left hand side of FIG. 1A, the lithium battery component 12 is provided. It is to be understood that the lithium battery component 12 described herein may be the porous membrane, the positive electrode, or the negative electrode. Examples of the porous membrane, the positive electrode, and the negative electrode will now be discussed.

An example of the porous membrane may be a polyolefin. The polyolefin may be a homopolymer (derived from a single monomer constituent) or a heteropolymer (derived from more than one monomer constituent), and may be either linear or branched. If a heteropolymer derived from two monomer constituents is employed, the polyolefin may assume any copolymer chain arrangement including those of a block copolymer or a random copolymer. The same holds true if the polyolefin is a heteropolymer derived from more than two monomer constituents. As examples, the polyolefin may be polyethylene (PE), polypropylene (PP), a blend of PE and PP, or multi-layered structured microporous films of PE and/or PP. Commercially available polyolefin porous polymer separators include CELGARD® 2500 (a monolayer polypropylene separator) and CELGARD® 2320 (a trilayer polypropylene/polyethylene/polypropylene separator) available from Celgard LLC.

Other examples of the porous membrane include a porous glass membrane or an array of nanotubes (e.g., titanium nanotubes). Still other examples of the porous membrane include polyethylene terephthalate (PET), polyvinylidene fluoride (PVdF), polyamides (Nylons), polyurethanes, polycarbonates, polyesters, polyetheretherketones (PEEK), polyethersulfones (PES), polyimides (PI), polyamide-imides, polyethers, polyoxymethylene (e.g., acetal), polybutylene terephthalate, polyethylenenaphthenate, polybutene, polyolefin copolymers, acrylonitrile-butadiene styrene copolymers (ABS), polystyrene copolymers, polymethylmethacrylate (PMMA), polyvinyl chloride (PVC), polysiloxane polymers (such as polydimethylsiloxane (PDMS)), polybenzimidazole (PBI), polybenzoxazole (PBO), polyphenylenes (e.g., PARMAX™ (Mississippi Polymer Technologies, Inc., Bay Saint Louis, Miss.)), polyarylene ether ketones, polyperfluorocyclobutanes, polytetrafluoroethylene (PTFE), polyvinylidene fluoride copolymers and terpolymers, polyvinylidene chloride, polyvinylfluoride, liquid crystalline polymers (e.g., VECTRAN™ (Hoechst AG, Germany) and ZENITE® (DuPont, Wilmington, Del.)), polyaramides, polyphenylene oxide, and/or combinations thereof. It is believed that another example of a liquid crystalline polymer that may be used for the porous membrane is poly(p-hydroxybenzoic acid). In yet another example, the porous membrane may be chosen from a combination of the polyolefin (such as PE and/or PP) and one or more of the listed polymers.

The porous membrane may be a single layer, a bilayer, or a multi-layer (e.g., having three or more layers) laminate fabricated from either a dry or wet process. For example, a single layer of the polyolefin and/or other listed polymer may constitute the entirety of the porous membrane. As another example, multiple discrete layers of similar or dissimilar polyolefins and/or polymers may be assembled into the porous membrane. In one example, a discrete layer of one or more of the polymers may be coated on a discrete layer of the polyolefin to form the porous membrane. In some instances, the porous membrane may include fibrous layer(s) to impart appropriate structural and porosity characteristics. It is to be understood that some of the mixture 20′ applied to the porous membrane to form the precursor coating 18 (and ultimately the polymer coating) will not only coat the outside of the porous membrane, but also penetrate into the pores of the porous membrane.

Furthermore, the porous membrane may have an average pore size of less than 1 micron. The porous membrane thickness may range from about 10 microns to about 50 microns.

The positive electrode may include an active material, a conductive filler, and a polymer binder. The positive electrode active material will depend on the type of battery in which the positive electrode will be used.

For a lithium-sulfur battery, the positive electrode active material may be formed from any sulfur-based active material that can sufficiently undergo lithium alloying and dealloying with aluminum or another suitable current collector functioning as the positive terminal of the lithium-sulfur battery. Examples of sulfur-based active materials include S₈, Li₂S₈, Li₂S₆, Li₂S₄, Li₂S₂, and Li₂S. Another example may be a sulfur-carbon composite, having a ratio of sulfur:carbon ranging from 1:9 to 9:1.

For a lithium ion battery, the positive electrode active material may be any lithium-based active material that can sufficiently undergo lithium insertion and deinsertion while aluminum or another suitable current collector is functioning as the positive terminal of the battery. The positive electrode active material may be selected from a common class of known lithium-based active materials. This class includes layered lithium transitional metal oxides. Some specific examples of the lithium-based active materials include spinel lithium manganese oxide (LiMn₂O₄), lithium cobalt oxide (LiCoO₂), a nickel-manganese oxide spinel [Li(Ni_{0.5}Mn_{1.5})O₂], or a lithium iron polyanion oxide, such as lithium iron phosphate (LiFePO₄) or lithium iron fluorophosphate (Li₂FePO₄F). In still another example, a layered nickel-manganese-cobalt oxide (LiNMC or NMC) [Li(NiₓMn_{y}Co_{z})O₂ or Li(NiₓMn_{y}Co_{z})O₄] may be used. In examples of the LiNMC, each of x, y, and z may be 1/3 (i.e., LiNMC 1,1,1), or the Ni content may be more, where x=0.6 and each of y and z=0.2 (i.e., LiNMC 6,2,2), or where x=0.8 and each of y and z=0.1, or where x=0.5, y=0.3, and z=0.2 (i.e., LiNMC 5,3,2), or the Mn content may be more than Ni and Co. Other lithium-based active materials may also be utilized, such as xLi₂MnO₃•(1-x)LiMO₂ (M is composed of any ratio of Ni, Mn and/or Co), LiNiₓM₁₋ₓO₂(M is composed of any ratio of Al, Co, and/or Mg), aluminum stabilized lithium manganese oxide spinel (LiₓMn₂₋ₓAl_{y}O₄), lithium vanadium oxide (LiV₂O₅), Li₂MSiO₄ (M is composed of any ratio of Co, Fe, and/or Mn), and any other high efficiency nickel-manganese-cobalt material. By “any ratio” it is meant that any element may be present in any amount. So, for example M could be Al, with or without Co and/or Mg, or any other combination of the listed elements.

The sulfur-based active material or the lithium-based active material of the positive electrode may be intermingled with the polymer binder and the conductive filler. Suitable binders include polyvinylidene fluoride (PVdF), an ethylene propylene diene monomer (EPDM) rubber, carboxymethyl cellulose (CMC), styrene-butadiene rubber (SBR), polyacrylic acid (PAA), polyvinyl alcohol (PVA), sodium alginate, styrene-butadiene rubber carboxymethyl cellulose (SBR-CMC), polyethylene oxide (PEO), poly(acrylamide-co-diallyl dimethyl ammonium chloride), cross-linked polyacrylic acid-polyethylenimine, other water-soluble or organic solvent based binders, or any other suitable binder material known to skilled artisans. The polymer binder structurally holds the sulfur-based active material or the lithium-based active materials and the conductive filler together. An example of the conductive filler is a high surface area carbon, such as acetylene black or activated carbon. The conductive filler ensures electron conduction between a positive-side current collector (e.g., aluminum) and the active material particles of the positive electrode. In an example, the positive electrode active material and the polymer binder may be encapsulated with carbon.

Turning now to the negative electrode as the lithium battery component 12, it is to be understood that any suitable negative electrode active material may be used for the lithium-sulfur battery or the lithium ion battery. Any lithium host material may be used that can sufficiently undergo lithium plating or intercalation or alloying and stripping or deintercalation or dealloying while copper or another suitable current collector is functioning as the negative terminal of the battery. In an example, the negative electrode active material is a silicon-based material that is prelithiated. In another example, the negative electrode active material is graphite. Graphite is widely utilized as the active material to form the negative electrode because it exhibits reversible lithium intercalation and deintercalation characteristics, is relatively non-reactive, and can store lithium in quantities that produce a relatively high energy density. Commercial forms of graphite that may be used to fabricate the negative electrode active material are available from, for example, Timcal Graphite & Carbon (Bodio, Switzerland), Lonza Group (Basel, Switzerland), or Superior Graphite (Chicago, Ill.). Other materials that can also be used to form the negative electrode active material include, for example, lithium titanate.

In other examples, the negative electrode may also include, in addition to the lithium host material (i.e., active material), a polymer binder to structurally hold the lithium host material together and a conductive filler. For example, the negative electrode may be formed of an active material, made from graphite or a low surface area amorphous carbon, intermingled with a binder, made from polyvinylidene fluoride (PVdF), an ethylene propylene diene monomer (EPDM) rubber, sodium alginate, carboxymethyl cellulose (CMC), or any of the examples previously listed for the positive electrode. These materials may be mixed with a high surface area carbon, such as acetylene black or activated carbon as the conductive filler, to ensure electron conduction between the current collector and the active material particles of the negative electrode.

Still referring to FIG. 1A, once the mixture 20′ is prepared and the lithium battery component 12 is provided, the lithium battery component 12 is introduced into the precursor 20/mixture 20′ to form the precursor coating 18 on the lithium battery component 12. In the example shown in FIG. 1A, the lithium battery component 12 is dipped or immersed in the precursor 20/mixture 20′ and then removed therefrom. Applying the mixture 20′ to the lithium battery component 12 is not limited to dipping or immersion. In other examples, the precursor 20/mixture 20′ may be applied to the lithium battery component 12 using any suitable technique, such as by spraying the mixture 20′, doctor blading the mixture 20′, or spin coating the mixture 20′.

After the coating process, it is to be understood that the lithium battery component 12 has the precursor coating 18 formed thereon (as shown on the right hand side of FIG. 1A).

Referring now to FIG. 1B, a system 200 for polymerizing the precursor coating 18 on the lithium battery component 12 is shown. The precursor coating 18 on the lithium battery component 12 is polymerized using a plasma source 42, which generates a plasma jet 24. In an example, any suitable air plasma device may be used as the plasma source 42. Examples of the air plasma device include an atmospheric pressure air plasma device or an open air plasma system. The plasma source 42 includes a plasma chamber 28 and a plasma flame 36 (generated in a plasma vaporization chamber 30, which is a combustion chamber for the flame 36), as well as a quenching area 34, and a cooling train 32.

In the system 200, a carrier gas 22 is delivered to the plasma chamber 28. Examples of suitable carrier gases 22 include argon (Ar), hydrogen gas (H₂), helium (He), nitrogen gas (N₂), oxygen gas, carbon monoxide (CO), or combinations thereof. It is to be understood that other gases, including other inert gases, may be used as well. The plasma chamber 28 creates the plasma flame 36 using the carrier gas 22 and a power source, such as a microwave, a direct current (DC), an alternating current (AC), or a radio frequency (RF) within the plasma vaporization chamber 30. It is to be understood that electrode(s) within the plasma vaporization chamber 30 ionize the carrier gas 22 to form the plasma jet 24, which is compressed air.

The carrier gas 22 is delivered to the plasma chamber 28 through a delivery mechanism 26. The delivery mechanism 26 may be any suitable polymeric, glass, stainless steel, copper, or other type of tubing. It is to be understood that the stream(s) of carrier gas 22 is/are transported as a result of pressure from a gas source.

The temperature of the plasma vaporization chamber 30 may be controlled by controlling the temperature of the plasma flame 36. The temperature of the plasma flame 36 may be controlled by altering/adjusting the power coupled into the plasma vaporization chamber 30 by the microwave, direct current (DC), alternating current (AC), or radio frequency (RF). In an example, the voltage applied to electrodes (not shown) of the plasma source 42 ranges from about 130 volts to about 250 volts. In an example, the temperature of the plasma flame 36 ranges from about 500° C. to about 5000° C., and the temperature of the plasma vaporization chamber 30 ranges from about 300° C. to about 1000° C.

The plasma flame 36 accelerates the plasma jet 24 into the quenching area 34 and then into the cooling train 32. At the quenching area 34 and within the cooling train 32, the plasma jet 24 is exposed to a much lower temperature than the plasma flame temperature. This lower temperature may be at or less than ambient or room temperature (e.g., less than 22° C.). This causes the plasma jet 24 to cool before it is applied to the precursor coating 18.

The plasma jet 24 is projected through the plasma nozzle 37 to direct the plasma jet 24 toward the precursor coating 18 on the lithium battery component 12. It is to be understood that the plasma nozzle 37 has an aperture adapted to effectively deliver the plasma jet 24 to the lithium battery component 12, which is coated with the precursor coating 18. In an example, the plasma jet 24 is projected out the plasma nozzle 37 at a velocity (rastering speed) up to about 20 mm/second (e.g., when the lithium battery component 12 is an electrode), or in other instances up to about 500 mm/second (e.g., when the lithium battery component 12 is a separator). In addition, the temperature of plasma jet 24 ranges from about 37° C. to about 93° C. It is to be understood that the temperature and velocity of the plasma jet 24 contribute to low energy atmospheric plasma, which activates the precursor coating 18 to form high bond strength with less thermal coefficient mismatch in the resulting polymerized polymer coating. It is believed that the combination of temperature and velocity also leads to minimal incorporation of contaminants into the polymerized polymer coating that is formed.

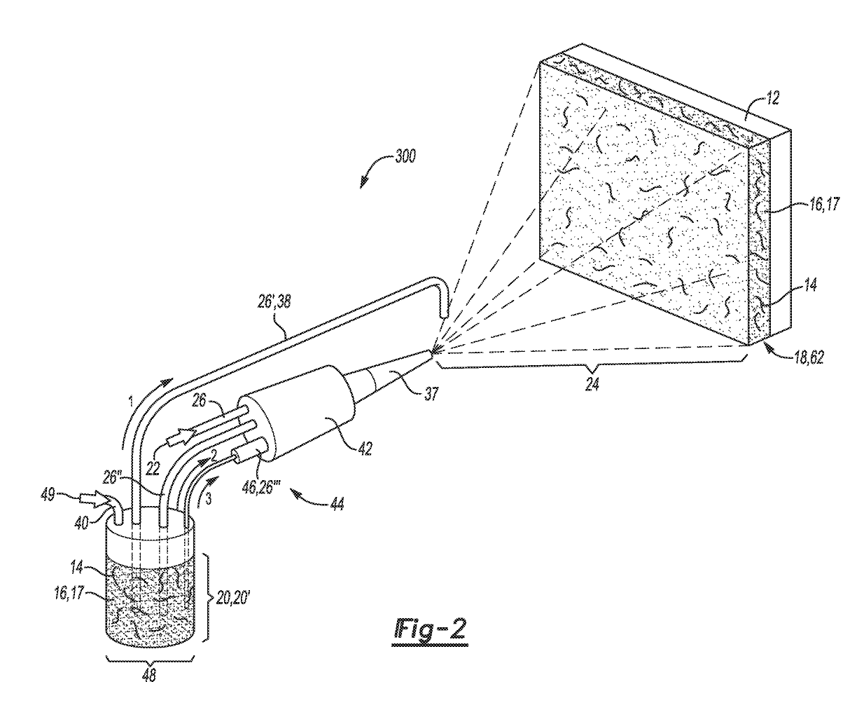

The distance between the end of the plasma nozzle 37 and the lithium battery component 12 having the precursor coating 18 thereon may range from about 1 cm to about 50 cm. In some examples, a desired range is from about 5 cm to about 10 cm. In an example, the distance is about 6 cm. This relatively short distance may be suitable for use in the example of the method described in reference to FIG. 2, in part because the mixture 20′ is applied using the plasma jet 24. The inertia of the components 14, 16, 17 of the mixture 20′ is low (due in part to relatively stable plasma conditions, such as temperature and velocity).

The exposure of the plasma jet 24 to the precursor coating 18 causes the monomers 14 to polymerize. As a result, a polymer coating 62 (see FIGS. 3A through 3C) is formed on the lithium battery component 12 (and in some instances, in the pores of the lithium battery component 12).

Referring now to FIG. 2, in another example of the method for preparing the coated lithium battery component, a plasma spray system 300 is used. In this example, the plasma spray system 300 is used to plasma spray the precursor 20/mixture 20′ directly onto the lithium battery component 12. The plasma spray system 300 includes the plasma source 42 and a delivery mechanism 26, 26′, 26″, 26′″.

The plasma source 42 includes all the components described in FIG. 1B above.

The delivery mechanism(s) 26, 26′, 26″, 26′″ may be integrated into the plasma source 42 or may be a stand-alone unit. Different examples of the delivery mechanisms 26, 26′, 26″, 26′″ are shown in FIG. 2. It is noted that the delivery mechanism 26 may be used in every example to deliver the carrier gas 22 to the plasma source 42 to produce the plasma jet 24.

In an example (labeled as “1” in FIG. 2), the delivery mechanism 26′ is used to deliver the precursor 20/mixture 20′ as a fine liquid-based stream through the outlet conduit 38 directly into the plasma jet 24. When delivery mechanism 26′ is used, the inlet conduit 40 may deliver a separate carrier gas 49 into the container 48, where it picks up the mixture 20′, which has the monomer 14, the electrolyte solvent 16, and the lithium compound 17 therein. The resulting mixed stream of the carrier gas 49 and the mixture 20′ is carried out of the container 48 through the outlet conduit 38 using delivery mechanism 26′. The resulting mixture 20′ with carrier gas 49 is delivered into the plasma jet 24. In other instances, the mixture 20′ is delivered without the carrier gas 49 into the plasma jet 24.

In another example (labeled as “2” in FIG. 2), the carrier gas 49 delivers the precursor 20/mixture 20′ into delivery mechanism 26″, which injects the mixture 20′ directly into the plasma source 42. In still another example (labeled “3” in FIG. 2), the carrier gas 49 delivers the mixture 20′ into the delivery mechanism 26′″, which injects the mixture 20′ into an atomizer 46, which atomizes or nebulizes the mixture 20′ into droplets that are introduced into the plasma source 42. In both examples 2 and 3, the carrier gas 49 can deliver the mixture 20′ to the plasma source 42 or atomizer 46 and be used to create the plasma jet 24. In these instances, the carrier gas 22 is not used. In other instances, carrier gas 49 is used to deliver the mixture 20′ to the plasma source 42 or atomizer 46 and carrier gas 22 is used to create the plasma jet 24.

Examples of the parameters of the plasma spray system 300 that may be adjusted include nozzle diameter, nozzle height, nozzle speed (i.e., the flow rate of the precursor 20/mixture 20′ through the nozzle), plasma voltage, plasma current, plasma power, and/or plasma cycle time.

It is to be understood that in some examples of the method, the precursor coating 18 may be simultaneously formed and polymerized. While the precursor 20/mixture 20′ is coated onto the lithium battery component 12 using the plasma jet 24 to form the precursor coating 18, the plasma jet 24 may also cause some of the monomer(s) 14 within the mixture 20′ to polymerize during the jetting process. In this example, polymerization may initiate while mixture 20′ is being applied, and may continue after the precursor coating 18 is formed. As such, in this example, the applied precursor coating 18 may include some monomer 14, electrolyte solvent 16, lithium compound 17 and some already formed polymer coating 62. The exposure to the plasma jet 24 may be continued in order to complete the polymerization. Once the polymerization is complete, the lithium battery component 12 is coated with the polymer coating 62.

The simultaneous forming and polymerizing of the precursor coating 18 on the lithium battery component 12 may be due, at least in part, to one or more parameters used when delivery the precursor 20/mixture 20′. In an example when the precursor 20/mixture 20′ is simultaneously applied and polymerized, the nozzle diameter may be about 5 mm, the nozzle height may range from about 2 cm to about 10 cm, the nozzle speed may be about 500 mm/s, the plasma voltage may be about 300 volts, the plasma current may be about 17 amps, the plasma power may be about 23 kHz, and the plasma cycle time may be 100%.

In other instances, the precursor 20 is applied using the plasma jet 24 without being polymerized during the jetting process. Even though the plasma jet 24 acts as a source of energy or initiator for polymerization, the monomers 14 in the precursor 20/mixture 20′ may not polymerize until they are deposited on the lithium battery component 12 and are further exposed to the plasma jet 24. The lack of polymerization of the monomers 14 in the plasma jet 24 may be due, at least in part, to one or more factors, such as the speed, the nozzle height, and the temperature at which the precursor 20 is delivered. For example, when the precursor 20 is applied but not polymerized in the plasma jet 24, the nozzle height (i.e., the distance from the tip of the plasma nozzle 37 to the lithium battery component 12) may be greater than or equal to 20 cm, the nozzle diameter may be greater than or equal to 5 mm, and the nozzle speed may be greater than or equal to 500 mm/s.

The feed rate of the precursor 20/mixture 20′ in this example of the method may vary as is desirable or suitable for a particular precursor 20/mixture 20′. In an example, the feed rate ranges from about 1 ml/min to about 500 ml/min. In another example, the feed rate ranges from about 20 ml/min to about 120 ml/min. The deposition rate of the mixture 20′ onto the lithium battery component 12 ranges from about 30% to about 70% of the selected feed rate.

In addition, the plasma spraying of the precursor 20/mixture 20′ may be continued for a suitable time to generate the coated lithium battery component (see 50, 50′, 50″ in FIGS. 3A through 3C), where the coating 62 has a desirable thickness. In an example, the thickness ranges from about 1 micron to about 20 microns, or more (e.g., up to about 200 microns). The thickness that may be achieved per pass of the plasma spray depends, at least in part on the process parameters. As such, multiple spraying passes may be required in order to achieve a desired thickness. In an example, from about one to about two spray passes achieves a thickness ranging from about 1 micron to about 20 microns.

In any of the examples disclosed herein, the plasma jet parameters may be varied depending, in part, on the precursor 20 that is being applied and on the lithium battery component 12 being coated. For example, lower speeds may be more suitable for coating electrodes to achieve a thick coat in one pass, while higher speeds may be more suitable for coating separators so as to not heat the separator too much.

Referring now to FIGS. 3A through 3B, each of the figures shows a coated lithium battery component 50, 50′, 50″ after polymerization of the precursor coating 18. The coated lithium battery component 50 depicts a coated porous membrane/separator, the coated lithium battery component 50′ depicts a coated positive electrode, and the coated lithium battery component 50″ depicts a coated negative electrode.

FIG. 3A shows the coated lithium battery component 50, i.e., the coated separator. In this example, the porous membrane 52, 12 is coated on one side with the polymer coating 62. It is to be understood, however, that the porous membrane 52, 12 can be coated so that the polymer coating 62 completely encloses the porous membrane 52, 12, or so that the polymer coating 62 is formed on opposed sides of the porous membrane 52, 12. While not shown, the polymer coating 62 can also penetrate the pores of the porous membrane 52, 12.

Another example of the coated lithium battery component 50′ is shown in FIG. 3B. This example is a coated positive electrode. In this example, one side of the positive electrode 54, 12 is coated with the polymer coating 62. In order to reduce polysulfide or transition metal shuffling during battery operation, it may be desirable to coat the positive electrode 54, 12 on the side that will face the porous membrane 52 (i.e., separator) in the battery. In other examples, the positive electrode 54, 12 may be enclosed in the polymer coating 62. While not shown, in some instances, the polymer coating 62 can also penetrate the pores of the positive electrode 54, 12. As long as the polymer coating 62 can swell and/or partially dissolve in the electrolyte, the penetration of the polymer coating 62 will not deleteriously affect the performance of the positive electrode 54, 12.

Yet another example of the coated lithium battery component 50″ is shown in FIG. 3C, and as noted above, this example is the coated negative electrode. In this example, one side of the negative electrode 56, 12 is coated with the polymer coating 62. In order to reduce polysulfide or transition metal shuffling during battery operation, it may be desirable to coat the negative electrode 56 on the side that will face the porous membrane 52 (i.e., separator) in the battery. In other examples, the negative electrode 56, 12 may be enclosed in the polymer coating 62. While not shown, in some instances, the polymer coating 62 can also penetrate the pores of the negative electrode 56, 12. As long as the polymer coating 62 can swell and/or partially dissolve in the electrolyte, the penetration of the polymer coating 62 will not deleteriously affect the performance of the negative electrode 56, 12.

After the negative electrode 56, 12 has been coated, it may require an additional pre-lithiation step. Some examples of negative electrode active materials that require pre-lithiation are silicon, silicon-tin, tin-germanium, or antimony. In an example, the pre-lithiation of the negative electrode 56, 12 can be accomplished by plasma jetting a solvent containing a lithium compound, for example lithium carbonate, onto the coated lithium battery component 50″. In an example, the solvent used in pre-lithiation is a high vapor pressure solvent that can be jetted using the plasma jet 24 disclosed herein.

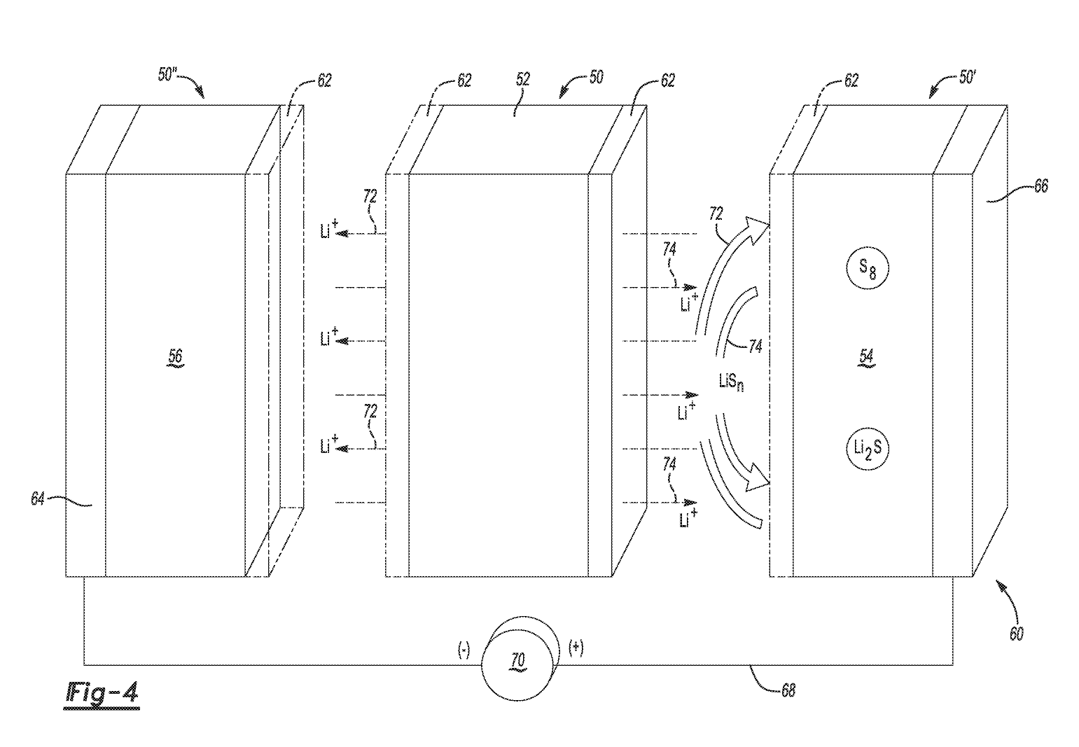

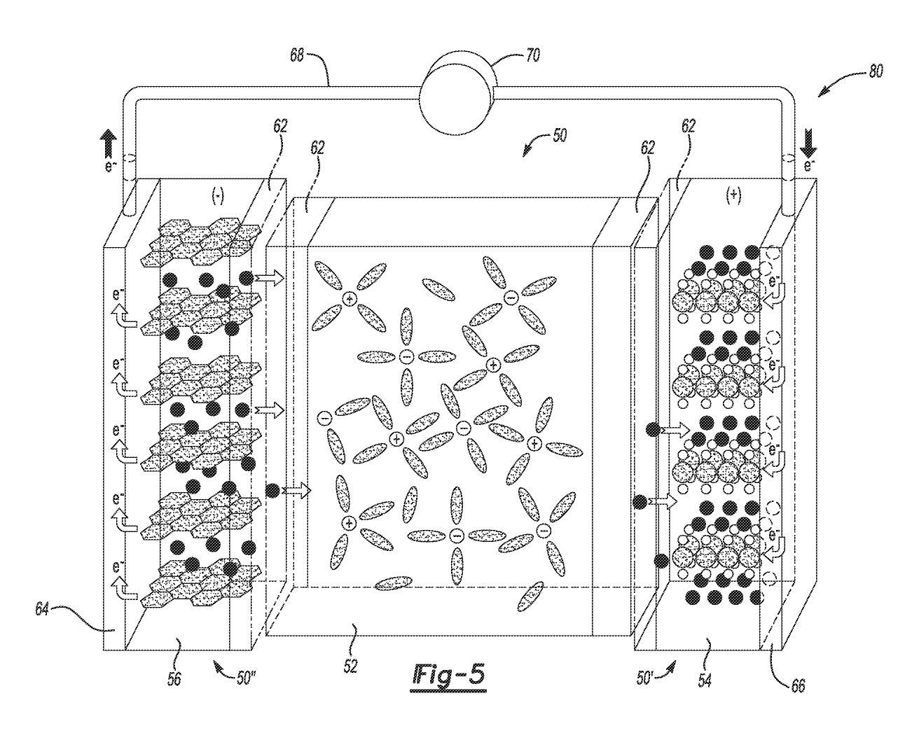

The various coated lithium electrode components 50, 50′, 50″ may be utilized in the lithium-sulfur battery and/or the lithium ion battery. Examples of these batteries will be described in reference to FIGS. 4 and 5.

Referring now to FIG. 4, the lithium-sulfur battery 60 includes the negative electrode 56, the positive electrode 54, and the porous membrane 52. At least one of these components has the polymer coating 62 formed thereon. The lithium-sulfur battery 60 also includes an interruptible external circuit 68 that connects the negative electrode 56 and the positive electrode 54.

The negative electrode 56, the positive electrode 54, and the porous membrane 52 are soaked in an electrolyte that is capable of conducting lithium ions. When the coated negative electrode 50″, the coated positive electrode 50′, and/or the coated porous membrane 50 is/are included, one or more of the components already has electrolyte material in the polymer coating 62, and any additional electrolyte solution will simply add to the lithium conductivity. It is to be understood that any of the electrolytes previously described for incorporation into the polymer coating 62 when the coating 62 is to be used in the lithium-sulfur battery, may be used as the additional electrolyte. Generally, the electrolyte may be the ether based solvent and the lithium salt dissolved therein.

The porous membrane 52, which operates as both an electrical insulator and a mechanical support, is sandwiched between the negative electrode 56 and the positive electrode 54 to prevent physical contact between the two electrodes 56, 54 and the occurrence of a short circuit. When the coated porous membrane 50 is used, it is to be understood that it may be positioned so that the bulk of the polymer coating 62 faces the positive electrode 54. The polymer coating 62 acts as a barrier layer between the porous membrane 52 and the positive electrode 54 in order to prevent the passage of polysulfide ions across the porous membrane 52. The porous membrane 52, in addition to providing a physical barrier between the two electrodes 56, 54 ensures passage of lithium ions (identified by the Li⁺) and some related anions through the polymer coating 62 and additional electrolyte filling its pores (not shown). It is to be understood that the polymer coating 62 may also be coated on the positive electrode 54, the negative electrode 56, or on the other side(s) and/or in the pores of the porous membrane 52 along with being coated on the side of the porous membrane 52 facing the positive electrode 54.

The positive electrode 54 and negative electrode 56 are formed of the materials previously described herein for lithium-sulfur batteries. The positive and negative electrodes 54, 56 are in contact, respectively, with current collectors 66, 64. The negative side current collector 64 may be formed from copper or any other appropriate electrically conductive material known to skilled artisans. The negative-side current collector 64 collects and moves free electrons to and from the external circuit 68. A positive-side current collector 66 may be formed from aluminum or any other appropriate electrically conductive material known to skilled artisans. The positive-side current collector 66 collects and moves free electrons to and from the external circuit 68.

The lithium-sulfur battery 60 may support a load device 70 that can be operatively connected to the external circuit 68, which connects the negative electrode 56 and positive electrode 54. The load device 70 receives a feed of electrical energy from the electric current passing through the external circuit 68 when the lithium-sulfur battery 60 is discharging. As such, the load device 70 may be powered fully or partially by the electric current passing through the external circuit 68 when the lithium-sulfur battery 60 is discharging. While the load device 70 may be any number of known electrically-powered devices, a few specific examples of a power-consuming load device include an electric motor for a hybrid vehicle or an all-electrical vehicle, a laptop computer, a cellular phone, and a cordless power tool. The load device 70 may also, however, be an electrical power-generating apparatus that charges the lithium-sulfur battery 60 for purposes of storing energy. For instance, the tendency of windmills and solar panels to variably and/or intermittently generate electricity often results in a need to store surplus energy for later use.

The lithium-sulfur battery 60 can include a wide range of other components that, while not depicted here, are nonetheless known to skilled artisans. For instance, the lithium-sulfur battery 60 may include a casing, gaskets, terminals, tabs, and any other desirable components or materials that may be situated between or around the negative electrode 56 and the positive electrode 54 for performance-related or other practical purposes. Moreover, the size and shape of the lithium-sulfur battery 60, as well as the design and chemical make-up of its main components, may vary depending on the particular application for which it is designed. Battery-powered automobiles and hand-held consumer electronic devices, for example, are two instances where the lithium-sulfur battery 60 would most likely be designed to different size, capacity, and power-output specifications. The lithium-sulfur battery 60 may also be connected in series and/or in parallel with other similar lithium-sulfur batteries 60 to produce a greater voltage output and current (if arranged in parallel) or voltage (if arranged in series) if the load device 70 so requires.

The lithium-sulfur battery 60 can generate a useful electric current during battery discharge (shown by reference numeral 74 in FIG. 4). During discharge, the chemical processes in the battery 60 include lithium (Li⁺) dissolution from the surface of the negative electrode 56 and incorporation of the lithium cations into alkali metal polysulfide salts (i.e., Li₂S) in the positive electrode 54. As such, polysulfides are formed (sulfur is reduced) on the surface of the positive electrode 54 in sequence while the battery 60 is discharging. The chemical potential difference between the positive electrode 54 and the negative electrode 56 (ranging from approximately 1.5 volts to 3.0 volts, depending on the exact chemical make-up of the electrodes 56, 54) drives electrons produced by the dissolution of lithium at the negative electrode 56 through the external circuit 68 towards the positive electrode 54. The resulting electric current passing through the external circuit 68 can be harnessed and directed through the load device 70 until the lithium in the negative electrode 56 is depleted and the capacity of the lithium-sulfur battery 60 is diminished, or until the level of lithium in the negative electrode 56 falls below a workable level, or until the need for electrical energy ceases.

The lithium-sulfur battery 60 can be charged or re-powered at any time by applying an external power source to the lithium-sulfur battery 60 to reverse the electrochemical reactions that occur during battery discharge. During charging (shown at reference numeral 72 in FIG. 4), lithium plating to the negative electrode 56 takes place, and sulfur formation at the positive electrode 54 takes place. The connection of an external power source to the lithium-sulfur battery 60 compels the otherwise non-spontaneous oxidation of lithium at the positive electrode 54 to produce electrons and lithium ions. The electrons, which flow back towards the negative electrode 56 through the external circuit 68, and the lithium ions (Li^{|}), which are carried by the electrolyte across the porous membrane 52 (including the polymer coating(s) 62 present on the positive electrode 54, the porous membrane 52 and/or the negative electrode 56) back towards the negative electrode 56, reunite at the negative electrode 56 and replenish it with lithium for consumption during the next battery discharge cycle. The external power source that may be used to charge the lithium-sulfur battery 60 may vary depending on the size, construction, and particular end-use of the lithium-sulfur battery 60. Some suitable external power sources include a battery charger plugged into an AC wall outlet and a motor vehicle alternator.

Referring now to FIG. 5, the lithium ion battery 80 includes the negative electrode 56, the positive electrode 54, and the porous membrane 52. At least one of these components has the polymer coating 62 formed thereon. The lithium ion battery 80 also includes the interruptible external circuit 68 that connects the negative electrode 56 and the positive electrode 54.

The negative electrode 56 and the positive electrode 54, and the porous membrane 52 are soaked in an electrolyte that is capable of conducting lithium ions. When the coated negative electrode 50″, the coated positive electrode 50′, and/or the coated porous membrane 50 is/are included, one or more of the components already has electrolyte material in the polymer coating 62, and any additional electrolyte solution will simply add to the lithium conductivity. It is to be understood that any of the electrolytes previously described for incorporation into the polymer coating 62 when the coating 62 is to be used in the lithium ion battery, may be used as the additional electrolyte. Generally, the electrolyte may be the organic solvent and the lithium salt dissolved therein.

Any example of the negative electrode 56, the negative-side current collector 64, and the positive-side current collector 66 described herein may be used in the lithium ion battery 80. In addition, the positive electrode 54 may be formed of any of the materials described herein for the lithium ion battery positive electrode (e.g., lithium transition metal oxide based active material).

Furthermore, the porous membrane 52, which operates as both an electrical insulator and a mechanical support, is sandwiched between the negative electrode 56 and the positive electrode 54 to prevent physical contact between the two electrodes 56, 54 and the occurrence of a short circuit. When the coated porous membrane 50 is used, the coated porous membrane 50 is positioned so that the bulk of the polymer coating 62 faces the positive electrode 54. The polymer coating 62 acts as a barrier layer between the porous membrane 52 and the positive electrode 54 in order to prevent the passage of manganese (or other transition metal) ions across the porous membrane 52. The porous membrane 52, in addition to providing a physical barrier between the two electrodes 56, 54, ensures passage of lithium ions (identified by the black dots and by the open circles having a (+) charge in FIG. 5) and some related anions through the electrolyte solution filling its pores, and integrated into the polymer coating 62.

The lithium ion battery 80 may support a load device 70 that can be operatively connected to the external circuit 68. The load device 70 receives a feed of electrical energy from the electric current passing through the external circuit 68 when the lithium ion battery 80 is discharging. Any examples of the load device 70 provided herein may be used in the lithium ion battery 80.

The lithium ion battery 80 can also include a wide range of other components that, while not depicted here, are nonetheless known to skilled artisans. For instance, the lithium ion battery 80 may include a casing, gaskets, terminals, tabs, and any other desirable components or materials that may be situated between or around the negative electrode 56 and the positive electrode 54 for performance-related or other practical purposes. Moreover, the size and shape of the lithium ion battery 80, as well as the design and chemical make-up of its main components, may vary depending on the particular application for which it is designed. Battery-powered automobiles and hand-held consumer electronic devices, for example, are two instances where the lithium ion battery 80 would most likely be designed to different size, capacity, and power-output specifications. The lithium ion battery 80 may also be connected in series and/or in parallel with other similar lithium ion batteries 80 to produce a greater voltage output and current (if arranged in parallel) or voltage (if arranged in series) if the load device 70 so requires.

The lithium ion battery 80 generally operates by reversibly passing lithium ions between the negative electrode 56 and the positive electrode 54. In the fully charged state, the voltage of the battery 80 is at a maximum (typically in the range 2.0 volts to 5.0 volts); while in the fully discharged state, the voltage of the battery 80 is at a minimum (typically in the range 0 volts to 3.0 volts). Essentially, the Fermi energy levels of the active materials in the positive and negative electrodes 54, 56 change during battery operation, and so does the difference between the two, known as the battery voltage. The battery voltage decreases during discharge, with the Fermi levels getting closer to each other. During charge, the reverse process is occurring, with the battery voltage increasing as the Fermi levels are being driven apart. During battery discharge, the external load device 70 enables an electronic current flow in the external circuit 68 with a direction such that the difference between the Fermi levels (and, correspondingly, the cell voltage) decreases. The reverse happens during battery charging: the battery charger forces an electronic current flow in the external circuit 68 with a direction such that the difference between the Fermi levels (and, correspondingly, the cell voltage) increases.

At the beginning of a discharge, the negative electrode 56 of the lithium ion battery 80 contains a high concentration of intercalated lithium while the positive electrode 54 is relatively depleted. When the negative electrode 56 contains a sufficiently higher relative quantity of intercalated lithium, the lithium ion battery 80 can generate a useful electric current during battery discharge by way of reversible electrochemical reactions that occur when the external circuit 68 is closed to connect the negative electrode 56 and the positive electrode 54 at a time when the negative electrode 56 contains a sufficiently high relative quantity of intercalated lithium. The chemical potential difference between the positive electrode 54 and the negative electrode 56 (ranging from approximately 1.5 volts to 5.0 volts, depending on the exact chemical make-up of the electrodes 56, 54) drives electrons (e⁻) produced by the oxidation of intercalated lithium at the negative electrode 56 through the external circuit 68 towards the positive electrode 54. Lithium ions, which are also produced at the negative electrode 56, are concurrently carried by the electrolyte solution through the porous membrane 52 (and polymer coating(s) 62) and towards the positive electrode 54. The electrons (e⁻) flowing through the external circuit 68 and the lithium ions migrating across the porous membrane 52 in the electrolyte eventually reconcile and form intercalated lithium at the positive electrode 54. The electric current passing through the external circuit 68 can be harnessed and directed through the load device 70 until the intercalated lithium in the negative electrode 56 falls below a workable level or is depleted, or the need for electrical energy ceases.

The lithium ion battery 80 may be recharged after a partial or full discharge of its available capacity. To charge the lithium ion battery 80, an external battery charger is connected to the positive and the negative electrodes 54, 56 to drive the reverse of battery discharge electrochemical reactions. The connection of an external power source to the lithium ion battery 80 compels the otherwise non-spontaneous oxidation of lithium transition metal oxide at the positive electrode 54 to produce electrons and release lithium ions. The electrons (e⁻), which flow back towards the negative electrode 56 through the external circuit 68, and the lithium ions, which are carried by the electrolyte across the porous membrane 52 (and polymer coating(s) 62) back towards the negative electrode 56, reunite at the negative electrode 56 and replenish the negative electrode 56 with intercalated lithium for consumption during the next battery discharge cycle. In this example, while the polymer coating 62 allows the lithium ions to pass through its pores, it also blocks the passage of manganese (or other transition metal) cations from the positive electrode 54 to the negative electrode 56.

The external power source that may be used to charge the lithium ion battery 80 may vary depending on the size, construction, and particular end-use of the lithium ion battery 80. Some suitable external power sources include a battery charger plugged into an AC wall outlet and a motor vehicle alternator.

It is to be understood that the ranges provided herein include the stated range and any value or sub-range within the stated range. For example, a range of about 10 microns to about 50 microns should be interpreted to include not only the explicitly recited limits of about 10 microns to about 50 microns, but also to include individual values, such as 25 microns, 42 microns, 49.5 microns, etc., and sub-ranges, such as from about 15 microns to about 45 microns; from about 20 microns to about 40 microns, etc. Furthermore, when “about” is utilized to describe a value, this is meant to encompass minor variations (up to +/− 5%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A method for preparing a coated lithium battery component, comprising:
providing a lithium battery component, the lithium battery component being selected from the group consisting of a porous membrane, a positive electrode, and a negative electrode;
coating the lithium battery component with a precursor including a mixture of an electrolyte solvent, a lithium compound, and a monomer, thereby forming a precursor coating on the lithium battery component; and
exposing the precursor coating to a plasma jet, thereby causing polymerization of the precursor to form a polymer coating on the lithium battery component.

2. The method as defined in claim 1 wherein the coating of the lithium battery component includes introducing the mixture to the plasma jet.

3. The method as defined in claim 1 wherein the coating of the lithium battery component includes immersing the lithium battery component in the mixture, or spraying, doctor blading, or spin coating the mixture onto a surface of the lithium battery component.

4. The method as defined in claim 1, further comprising forming the mixture by homogenously mixing the electrolyte solvent, the lithium compound, and the monomer in an other solvent.

5. The method as defined in claim 1 wherein the monomer is selected from the group consisting of methyl methacrylate with or without SiO₂ particles or Al₂O₃ particles, acrylonitrile with or without SiO₂ particles or Al₂O₃ particles, vinyl chloride, polyethylene glycol diacrylate, ethylene oxide, and a combination of vinylidene fluoride and hexafluoropropylene.

6. The method as defined in claim 1 wherein:
the lithium battery component is a lithium ion battery component;
the electrolyte solvent is an organic solvent;
the organic solvent is selected from the group consisting of cyclic carbonates, linear carbonates, aliphatic carboxylic esters, γ-lactones, chain structure ethers, cyclic ethers, and mixtures thereof; and
the lithium compound is selected from the group consisting of LiClO₄, LiAlCl₄, LiI, LiBr, LiSCN, LiBF₄, LiB(C₆H₅)₄, LiAsF₆, LiCF₃SO₃, LiN(FSO₂)₂ (LIFSI), LiN(CF₃SO₂)₂ (LITFSI), LiPF₆, LiB(C₂O₄)₂ (LiBOB), LiBF₂(C₂O₄) (LiODFB), LiPF₄(C₂O₄) (LiFOP), LiNO₃, and mixtures thereof.

7. The method as defined in claim 1 wherein:
the lithium battery component is a lithium-sulfur battery component;
the electrolyte solvent is an ether based solvent;
the ether based solvent is selected from the group consisting of 1,3-dioxolane, tetrahydrofuran, 2-methyltetrahydrofuran, 1,2-dimethoxyethane, 1-2-diethoxyethane, ethoxymethoxyethane, tetraethylene glycol dimethyl ether (TEGDME), polyethylene glycol dimethyl ether (PEGDME), and mixtures thereof; and
the lithium compound is selected from the group consisting of LiClO₄, LiAlCl₄, LiI, LiBr, LiSCN, LiBF₄, LiB(C₆H₅)₄, LiAsF₆, LiCF₃SO₃, LiN(FSO₂)₂ (LIFSI), LiN(CF₃SO₂)₂ (LITFSI), LiPF₆, LiB(C₂O₄)₂ (LiBOB), LiBF₂(C₂O₄) (LiODFB), LiPF₄(C₂O₄) (LiFOP), LiNO₃, and mixtures thereof.

8. The method as defined in claim 1 wherein:
the lithium battery component is a negative electrode;
the negative electrode is porous carbon; and
the mixture is a solution of the electrolyte solvent, the lithium compound, and from about 40% to about 50% of a silicon precursor as the monomer.

9. The method as defined in claim 1 wherein:
the lithium battery component is a positive electrode for a lithium-sulfur battery; and
the positive electrode includes a sulfur based active material selected from the group consisting of S₈, Li₂S₈, Li₂S₆, Li₂S₄, Li₂S₂, Li₂S, and a sulfur-carbon composite.

10. The method as defined in claim 1 wherein:
the lithium battery component is a positive electrode for a lithium ion battery; and
the positive electrode includes a lithium transition metal oxide based active material selected from the group consisting of LiMn₂O₄, Li(Ni_{0.5}Mn_{1.5})O₂, Li(NiₓMn_{y}Co_{z})O₂, Li(NiₓMn_{y}Co_{z})O₄, LiCoO₂, LiNiO₂, LiFePO₄, Li₂FePO₄F, LiV₂O₅, Li₂MSiO₄ (M═Co, Fe, Mn, or a combination thereof), xLi₂MnO₃•(1-x)LiMO₂ (M is composed of any ratio of Ni, Mn and Co), LiNiₓM₁₋ₓO₂(M═Al, Co, Mg, or a combination thereof), and LiₓMn₂₋ₓAl_{y}O₄.

11. The method as defined in claim 1 wherein the polymer coating includes a cation other than a lithium cation and is not lithium conducting, and wherein the method further comprises ion exchanging the cation of the polymer coating with a lithium cation.

12. The method as defined in claim 1 wherein:
the lithium battery component is a negative electrode; and
the method further comprises pre-lithiating the coated lithium battery component by depositing a solvent and a lithium compound on the coated lithium battery component using the plasma jet.

13. The method as defined in claim 1 wherein any of:
i) the mixture completely encloses the lithium battery component during the coating of the lithium battery component;
ii) the lithium battery component is the negative electrode, and during the coating of the lithium battery component, the mixture coats a side of the negative electrode that is to face the porous membrane in a battery;
iii) the lithium battery component is the porous membrane, and during the coating of the lithium battery component, the mixture coats an outside of the porous membrane and penetrates pores of the porous membrane; or
iv) the lithium battery component is the positive electrode, and during the coating step, the mixture coats a side of the positive electrode that is to face the porous membrane in a battery.

14. The method as defined in claim 1 wherein the exposing of the precursor coating to the plasma jet is performed at a temperature ranging from about 37° C. to about 93° C. and a feed rate ranging from about 1 ml/min to about 500 ml/min.

15. The method as defined in claim 14 wherein one of:
i) the coating of the lithium battery component is performed using a nozzle height ranging from about 2 cm to about 10 cm; or ii) the coating of the lithium battery component is performed using the nozzle height of about 20 cm.

16. The method as defined in claim 1 wherein the coating of the lithium battery component is performed by plasma spraying the mixture onto the lithium battery component in a range of about one pass to about two passes of the plasma jet.

17. A method for preparing a coated lithium battery component, comprising:
providing a lithium battery component, the lithium battery component being selected from the group consisting of a porous membrane, a positive electrode, and a negative electrode;
adding a precursor directly into a plasma jet, the precursor including a mixture of an electrolyte solvent, a lithium compound, and a monomer; and
coating the lithium battery component with the precursor using the plasma jet, whereby the precursor polymerizes to form a polymer coating on the lithium battery component.

18. The method as defined in claim 17 wherein coating the lithium battery component with the precursor forms a precursor coating, and wherein the method further includes continuing to expose the precursor coating to the plasma jet.

19. The method as defined in claim 18 wherein:
the plasma jet is about 6 cm from the lithium battery component coated with the precursor coating;
the plasma jet has a voltage ranging from about 150 volts to about 250 volts; and
the plasma jet has a velocity ranging from about 1 mm/s to about 20 mm/s.

20. The method as defined in claim 17 wherein polymerization of the monomer in the precursor at least partially takes place while coating the lithium battery component with the precursor using the plasma jet.
